(19) United States
(12) Patent Application Publication
(10) Pub. No.: US 2012/0131657 A1
(43) Pub. Date: May 24, 2012

(54) Apparatus and Method for Authenticated Multi-User Personal Information Database

(75) Inventors: Bruce D. Sunstein, Rockport, MA (US); Eileen C. Shapiro, Cambridge, MA (US)

(73) Assignee: GOLD STANDARD TECHNOLOGY LLC, Cambridge, MA (US)

(21) Appl. No.: 13/364,079

(22) Filed: Feb. 1, 2012

Related U.S. Application Data
(63) Continuation of application No. 11/285,762, filed on Nov. 22, 2005, now abandoned.
Application No. 11/285,762 is a continuation-in-part of application No. 09/448,722, filed on Nov. 24, 1999, now Pat. No. 6,985,887.
(60) Provisional application No. 60/125,234, filed on Mar. 19, 1999.

(51) Int. Cl. H04L 9/32

(52) U.S. Cl. 726/6

(57) ABSTRACT

A method of assuring integrity of a personal information in a data base, containing personal information provided by multiple users, uses in various embodiments physiological identifiers associated with each of the users. Related systems are also provided. A user may be notified if a merchant verification request to the data base has produced a non-match event.

The present application is a continuation of application Ser. No. 11/285,762, filed on Nov. 22, 2005, which is a continuation-in-part of application Ser. No. 09/448,722, filed Nov. 24, 1999, issued as U.S. Pat. No. 6,985,887, and claims priority from provisional application Ser. No. 60/125,234, filed Mar. 19, 1999, for inventions of the same inventors and title as herein; such applications are hereby incorporated herein by reference.

### TECHNICAL FIELD

The present invention relates to personal information and medical databases, and particularly to databases used in connection with financial transactions and medical emergencies.

### BACKGROUND ART

With the rise of digital communications for a wide range of applications, it is now a commonplace for important financial transactions, and even everyday transactions, to occur over networks of all kinds, including local area networks (LANs and intranets), wide area networks (WANs and extranets), and the Internet. Formerly these transactions were in many cases conducted in person or over the telephone under circumstances where it was often relatively easy for each person to be assured that the other party is actually the person who the party purports to be—namely, to be assured that the party is authentic. Moreover, such transactions commonly occurred under conditions where the universe of potential parties was relatively limited. Authenticity could under those circumstances often be determined by visual inspection (when the transaction is in person) or by personal recognition of a voice (when the transaction is over the telephone).

When the transactions are conducted over a network, identifying information associated with in-person or telephone-based transactions is far more difficult to obtain. Moreover, the universe of potential parties to such transactions is significantly expanded. These circumstances provide an opportunity for individuals to misappropriate in whole or in part the identity of another person for personal gain or other improper purposes. A partial misappropriation of identity occurs in the case of credit card fraud. In addition there are increasing instances of wholesale identity theft, where the perpetrator assumes the identity of another for a continuing series of fraudulent transactions. Indeed, even in-person and telephone-based transactions provide opportunities for identity theft.

In addition, the ubiquitous nature of the Internet has had an effect on information, essentially personal in nature, which has formerly inhabited the domain of private individuals and their immediate communities, and made that information available to the public; the Internet allows much private information to be transformed into public information. Associated with this loss of privacy is in general a greater risk of identity theft.

Central credit card registries exist to provide credit card owners with a single point of reference for registering credit card numbers and, optionally, providing selected other services for dealing with lost or stolen credit cards (e.g., notifying credit card issuers of the theft). However, a credit card registry may itself be used by an unscrupulous individual to perpetrate an identity theft, whereby, for example, a fraudulent change of address may be given to multiple credit card issuers via a credit card registry.

Smart cards typically include data pertaining to the card holder, but in many instances, smart cards will not protect against identity theft; indeed, even with enhanced security, it may be assumed that smart thieves will or could find ways to steal smart cards and that the information stored on these cards may also be stolen.

In another context, authentication-related issues may be important when a person may have critical information to impart but is unexpectedly impaired (for example by reason of an accident or a stroke while traveling alone, etc.). The impaired person, for example, may have certain strictures governing medical treatment (for example, allergy to penicillin) or important preferences as to the scope of medical treatment to be rendered under life-threatening conditions and as to persons to be involved in deciding about such treatment.

### SUMMARY OF THE INVENTION

In a first embodiment, the invention provides a method of administering registration of personal information in a data base in a manner tending to assure integrity of the personal information therein. The method includes:

a. obtaining, from each user with respect to whom data is to be placed in the data base, personal information of such user, the content of such personal information initially established by such user in an enrollment phase;
b. also obtaining, from each such user, a first set of physiological identifiers associated with such user, the first set of physiological identifiers initially provided by such user in the enrollment phase;
c. storing, in a digital storage medium, a data set pertinent to such user, the data set including such user's personal information and a representation of the physiological identifiers associated with such user; and
d. permitting a subject claiming to be a specified user to modify the specified user's personal information in the stored data set pertinent to such user only if (i) the subject provides a new set of physiological identifiers and (ii) it is determined, by recourse to the stored data set, that there is a sufficient match between at least one member in the new set and a corresponding member of the first set, so that the subject is authenticated as the specified user, so that there is established a repository of personal information using physiological identifiers to protect against unauthorized modification.

What this embodiment may achieve in some aspects is a circumstance wherein individual identity may be established by a user in a proprietary database and wherein that identity is safeguarded. In this manner the user is put in control of the content relating to his identity, but parameters relevant to that identity may be changed only under conditions wherein the risk of identity theft is reduced.

In a further embodiment, the method includes obtaining a user's medical information from the user, and the data set includes the user's medical information.

### DEFINITIONS

As used in this description and the accompanying claims, the following terms shall have the meanings indicated, unless the context otherwise requires:

(i) A user's “personal information” includes (a) any alphanumeric identifier of a particular natural person used or issued by a governmental authority or a merchant in connection with the user, such as a credit card number of the user, the user's passport number, the user's social security number, the user's tax identification number, driver's licence number, checking account numbers, etc., together with the identity of the governmental authority, banking or financial institution in each case; (b) the user's name; and (c) contact information pertinent to the user. Optionally, “personal information” may include any or all of the following: (i) any variant of the user's name used by such governmental authority or merchant and (ii) the particular contact information used by such governmental authority or merchant for communicating with the user.

(ii) A “merchant” includes any banking or financial institution or any person or entity (including a retail establishment, hospital, or educational institution} providing services or goods for monetary consideration.

(iii) “Contact information” pertinent to a natural person includes information pertinent to communicating with the person, such as the person's home or business address or telephone number or E Mail address or billing address.

(iv) A user's “medical information” includes (a) the name of a natural person, in a caring relation to the user, whom the user wishes to be notified in the event of the user's illness, injury, or death and (b) contact information pertinent to the caring natural person. Optionally, “medical information” may include any or all of the following: (i) medical and dental treatment information, including medical conditions (such as allergy to penicillin) and dental conditions and religious requirements (for example barring blood transfusions), important to treating the user under emergency circumstances; (ii) information concerning participation by the user in any organ donor program; (iii) health proxy and living will information, concerning scope of medical treatment desired by the user under severe medical circumstances; (iv) the name of any person holding a health proxy of the user and contact information pertinent to such person; and (v) health provider information (including for dental care) and health insurance information (including for dental care) pertinent to the user.

(v) A “physiological identifier associated with a user” is physiological feature of the user, capable of uniquely identifying the user, such as, for example, the appearance of the user's face, a fingerprint of the user, the configuration of an iris in an eye of the user, the user's voice or speech (that is, characteristics of utterances of the user), a sample of the user's DNA, or the sequence of a relevant portion of such a DNA sample.

(vi) A “representation” of a physiological identifier is an abstraction, capable of being stored in a digital storage medium, of the physiological identifier, that retains characteristics of the identifier to a degree sufficient to permit reasonably reliable discrimination between the user and another natural person. The abstraction may, for example, be a digitized photograph of the user's face, and the photograph may be manually or automatically compared with the face of a subject purporting to be the user.

(vii) The term “set” is used in the mathematical sense, and a “set” is not empty; that is, a “set” has at least one member.

(viii) A “multiplicity” of terminals means at least three terminals.

(ix) A “physiological identifier transducer” includes any device (such as a fingerprint reader or a voice terminal/analyzer) that transforms physical information, derived from a physiological feature of a human subject that is capable of uniquely identifying the subject, into computer-readable data useful for identifying the subject.

(x) An account that “authorizes the transfer of funds” is one such as a checking account, a debit card account, or a credit card account.

(xi) An account that is “based on the extension of credit to the account holder” includes a wide variety of account relationships, including those based on the furnishing of goods or services wherein the cost of the goods or services is billed to the recipient or to a third party after the account is opened. Examples include health care services billed to an insurer, stock brokerage margin accounts, etc.

(xii) A “biometric-protected personal information data base” (“BPPIDB”) is a data base that is administered in accordance with the method set forth at the beginning of this Summary of the Invention.

In a further embodiment of the present invention, there is provided a method for authenticating an individual to a merchant. The method of this embodiment includes:

administering registration of personal information in a multi-user data base that is protected by physiological identifiers in the manner described above;

receiving a request from a merchant to authenticate data supplied by the individual;

accessing a record in the data base for an actual user corresponding to the individual;

comparing data in the record accessed with data supplied by the individual; and

notifying the merchant of the results of the comparing.

In related embodiments, the request from the merchant may be for verification of an address of the purported user and there may also be included notifying the actual user of the results of the comparing. Alternatively, there may be included determining whether the comparing shows a sufficient match between data in the record accessed with data supplied by the individual and, if there is not a sufficient match, notifying the actual user that a merchant verification request resulted in a non-match event. In further related embodiments notifying the actual user includes using contact information supplied by the user in the data base.

With respect to each of the above embodiments, optionally, the first set of physiological identifiers and the new set of physiological identifiers are obtained under supervision to assure authenticity of the identifiers and integrity of processes by which any personal information of the specified user in the data base is stored or modified.

In a series of further and important embodiments, the first set of physiological identifiers may include a plurality of members. In this way, the level of reliability in determination of authenticity may be selected in accordance with requirements of existing circumstances. For example, embodiments of the invention include methods and systems wherein the first set of identifiers includes at least one member selected from the group consisting of a fingerprint of the user and the configuration of an iris in an eye of the user and at least one member selected from the group consisting of characteristics of utterances of the user and the appearance of the user's face. These two groups offer differing levels of reliability—fingerprints and iris configuration offering potentially greater reliability than characteristics of utterances of the user and the appearance of the user's face, since both utterances and facial appearance can be disguised. On the other hand, it may be more convenient to utilize characteristics of utterances or facial appearance for authentication. In circumstances where such convenience outweighs the risks associated with the reduced level of reliability, these forms of authentication may be used, even though more reliable forms of authentication might be required, for example, for user modification of data in the user's data set.

A related embodiment of a system in accordance with the present invention provides a multiplicity of remotely distributed terminals in communication with the data base, and each terminal includes a physiological identifier transducer and a communication link to a merchant. (The communication link may be as simple as a telephone connection, or it may be a data network directly to the merchant or indirectly over a path that includes the data base, or it may be over the Internet.) In this fashion, a user may, for example, enter into a transaction with the merchant over the Internet or over the telephone, and then physically go to a location near the user where a terminal is located, and use the terminal to authenticate the transaction. Or the transaction may be entered into at the terminal at substantially the same time as it is authenticated. Transactions wherein this system may be used include, for example, those over a desired threshold amount. This system therefore includes a multi-user personal information data base, a multiplicity of remotely distributed terminals in communication with the data base and having a communication link with a merchant, and an authenticity checker which determines whether there is a sufficient match between the output of a physiological identifier transducer attributable to a subject purporting to be a user and a physiological identifier in the first. The data base includes, for each user, a data set pertinent to such user, and the data set including such user's personal information obtained from the user and a representation of a first set of physiological identifiers associated with the user.

In a further embodiment of methods and systems in accordance with the present invention, a subject is permitted to modify information in the stored data set only if the subject provides the new set of physiological identifiers under a condition permitting verification, independent of the physiological identifiers, that the new set is being provided by the person purporting to provide them. Such a condition may include the physical presence of the subject when providing the new set. Alternatively, or in addition, the condition may include having the subject provide the new set when prompted to do so or having the subject provide a non-physiological identifier. The non-physiological identifier may be selected from the group consisting of a password and a pass card. Alternatively, the non-physiological identifier is provided in the course of a session, over a computer network, employing a user's public and private keys.

In yet another related embodiment there is provided a method for authenticating a user transaction. The method includes obtaining a test set of physiological identifiers from a subject purporting to be the user and accessing information in the data set pertinent to the user stored in accordance with embodiments previously described. The method also includes determining if there is a sufficient match between at least one member in the test set and a corresponding physiological identifier represented in the data set. In a further related embodiment, the database is accessible via a server at a first location; obtaining the test of physiological identifiers is performed at a second location remote from the first location; and determining if there is a sufficient match includes communicating with the server from the second location over a network. The network may, for example, be a global communication network, such as the Internet. Optionally, obtaining the test set of physiological identifiers is performed under supervision of a merchant. As an additional option, determining if there is a sufficient match may be performed without revealing content of the first data set to the merchant. Indeed, the entire data base may be maintained in a manner that it is confidential to the merchant.

In further related embodiments, the transaction is a change of address for an account. In another embodiment, the transaction is an application to open an account. In either of these embodiments, the account may be one that authorizes the transfer of funds. Alternatively, or in addition, the account may be based on the extension of credit to the account holder.

In another further related embodiment, the transaction is an application to a government agency for one of a license and a renewal of a license. The license may be, for example, a driver's license or a passport, or a professional license. Alternatively, the transaction is an application to a government agency for one of an identification token and a renewal of an identification token. The identification token, for example, may be an identification card or a social security number.

In another embodiment, the invention provides a digital storage medium on which has been recorded a multi-user personal information data base. The data base includes, for each user, a data set pertinent to such user. This data set includes:

(a) such user's personal information obtained from the user;

(b) an authentication set of physiological identifiers associated with the user; and

(c) such user's emergency information obtained from the user.

In yet another embodiment the invention provides a system for updating a personal information database containing a data set for each one of multiple users. Each data set including a user's personal information and a representation of a first set of physiological identifiers associated with the user. The system of this embodiment includes:

a physiological identifier transducer having an output representing a physiological identifier associated with a subject;

a user access authorization module, coupled to the physiological identifier transducer, the database, for determining whether the output of the physiological identifier transducer sufficiently matches the representation of the first set of physiological identifiers, so that the subject is authenticated as the user;

a user data set access module, coupled to the user access authorization module and to the database, for accessing the user data set, in the event that the user access authorization module has authenticated the subject as the user; and

a user data set update module, coupled to the database and to a user input, permitting the user to update such user's corresponding data set in the database.

### BRIEF DESCRIPTION OF THE DRAWINGS

The foregoing features of the invention will be more readily understood by reference to the following detailed description, taken with reference to the accompanying drawings, in which:

FIG. 1 is a block diagram of a preferred embodiment of a method in accordance with the present invention;

FIG. 2 is a block diagram of an embodiment of the invention employed for authentication of a transaction;

FIG. 3 is illustrates in schematic form a structure for a database in accordance with an embodiment of the present invention;

FIG. 4 is a block diagram of an embodiment of the present invention providing a system for updating a personal information database containing a data set for each one of multiple users;

FIG. 5 is a block diagram illustrating operation of the user access authorization module 43 of FIG. 4;

FIG. 6 is a block diagram of an embodiment of a system in accordance with the present invention providing a multiplicity of remotely distributed terminals in communication with a multi-user personal information data base; and

FIG. 7 is a block diagram illustrating a representative process in accordance with an embodiment of the invention implementing user notification of a non-match event when a sponsor of a biometric-protected personal information data base (BPPIDB) offers an address verification service or other authentication service to a merchant.

### DETAILED DESCRIPTION OF SPECIFIC EMBODIMENTS

In an important embodiment, the present invention provides for multiple users a central registration of information that is of critical importance to the user, and such information includes what we have defined above as “personal information” and “medical information” of the user. In this embodiment, the information content is established and modifiable only by the user (or, optionally, by a parent or guardian). Furthermore, the information is subject to authentication on the basis of one or more physiological identifiers of the user. Also, in this embodiment, information pertinent to the user is made available only on a selected basis to authorized parties and in accordance the appropriate context. Finally, the registration system in accordance with this embodiment may be managed in cooperation with law enforcement agencies to deter fraudulent use by providing physiological identifiers in the form, for example, of photographs and fingerprints, when probable cause has been established for disclosure to law enforcement agencies, as evidenced by the issuance of a search warrant.

An information registry that is consistently managed in accordance with the embodiment described in the previous paragraph may be expected to become a trusted source of the information which it stores. We have referred above to a “physiological identifier associated with a user” as a physiological characteristic of the user, capable of uniquely identifying the user. We gave as examples, the appearance of the user's face, a fingerprint of the user, the configuration of an iris in an eye of the user, characteristics of the user's voice or speech (i.e, characteristics of utterances of the user), a sample of the user's DNA, or the sequence of a relevant portion of such a DNA sample. Further information about the technology associated with the use of physiological identifiers of this nature in a computing environment appears in an article by G. Gunnerson, “Are you ready for Biometrics?”, 18 PC Magazine, No. 4, 160-178 (Feb. 23, 1999). This article, which is incorporated herein by reference in its entirety, discloses commercially available products to protect against unauthorized computer system access by utilization of a physiological identifier such as fingerprint, facial appearance, and characteristics of one's voice and speech, sometimes in tandem with a non-physiological identifier such as a smart card or a password. See also the content, which is hereby incorporated herein by reference in its entirety, of the following web sites: www.biometrics.org (The Biometric Consortium) and www.emory.edu/BUSINESS/et/biometric/(biometric technology explained at Emory University site),

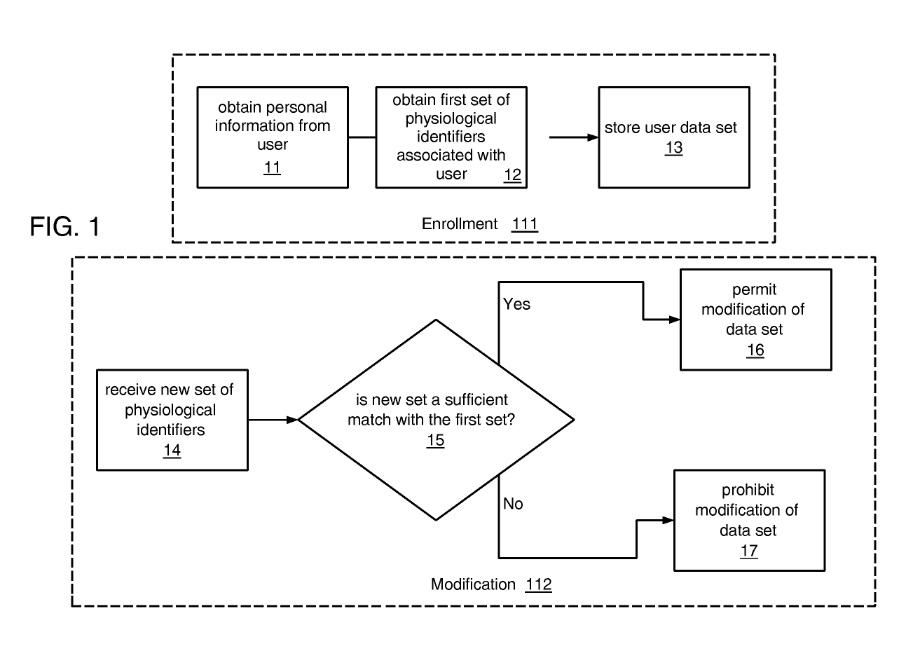

In FIG. 1 is shown a block diagram of a preferred embodiment of a method in accordance with the present invention. This embodiment includes two phases, an enrollment phase 111 and a modification phase 112. In the enrollment phase, personal information is obtained from the user in box 11. Optionally medical information is also obtained from the user. Next in box 12 there is obtained a first set of physiological identifiers associated with the user. In box 13 the user data set, which includes the user's personal information (and optionally medical information obtained from the user) and a representation of the physiological identifiers associated with the user, is stored in the database.

In order to reduce the risk of fraud, it is desirable to conduct the enrollment phase under supervision, wherein the process by which a set of physiological identifiers is obtained from the user is monitored by an individual to assure authenticity of the identifiers and integrity of the process by which any personal information and any medical information is stored: so that this information is associated with the same person as the one from whom the set of physiological identifiers is obtained. Without supervision, there is increased risk that the set of physiological identifiers is counterfeit—for example, an electronic construct derived from an image of the face of another person, or from the fingerprint of another person, or from the voice of another person. With supervision, the would-be imposter has a much more difficult time in substituting counterfeit physiological identifiers for legitimate identifiers. In the modification phase 112, a subject is permitted to modify data in the user's data set if it is determined that the subject is the user. In box 14, there is received a new set of physiological identifiers from the subject. In box 15, there is conducted a test to determine whether there is a sufficient match between the new set of physiological identifiers and the first set of physiological identifiers obtained in box 12. If the match is not sufficient, then in box 17 it is prohibited to modify the data set. Alternatively, if the match is sufficient, then, in box 16, the subject (who is authenticated as the user) is permitted to modify the data set. As in the case of enrollment, also to reduce the risk of fraud, it is desirable to conduct the modification phase under supervision, wherein the process by which the new set of physiological identifiers is obtained from the user is monitored by an individual to assure authenticity of the identifiers and integrity of the process by which any personal information and any medical information is modified: so that the modified information is associated with the same person as the one from whom the new set of physiological identifiers is obtained.

The set of physiological identifiers is used to protect the integrity of personal information and medical information deposited in the data base. Identity theft depends on the false attribution, to the thief, of information of the victim, and requiring physiological identifiers in the enrollment phase when information is deposited and in the modification phase when the information is modified, makes it very difficult for an imposter to change the information deposited in the database and therefore makes it very difficult for the imposter to attribute the deposited information to himself. A user of the data base is thus benefited by making a generous deposit of personal information in the data base, because the deposited information can less easily be dissociated from the user by the thief than undeposited information.

A user of the data base can also experience special benefits by generously depositing medical information in the data base. Medical information documents the physiological condition and the physiological history of the user. Information about the physiological condition of the user is effectively a supplement to the set of physiological identifiers provided by the user. Thus medical information that the user wears glasses, has false teeth, and is allergic to pollen helps distinguish the user on a physiological basis from other individuals. Medical history may also sometimes help to distinguish the user on a physiological basis from other individuals. For example, if the user's medical information shows that the user had surgery on the right knee, the user will have scars on the right knee consistent with the surgery, providing identification of the user that is in addition to the user's set of physiological identifiers. Dental records, in particular, which have been frequently used for identification of individuals (often deceased), are useful in this context. (See, for example, I. A. Pretty and D. Sweet, “A look at forensic dentistry—Part 1: The role of teeth in the determination of human identity,” British Dental Journal, Vol. 190, No. 7, (Apr. 14, 2001), pp. 359-366, reproduced at http://www.nature.com/cgi-taf/DynaPage.taf?file=/bdj/journal/v190/n7/full/4800972a.html, and incorporated herein by reference. The dental records having the most value in this context are those maintained over an extended period of time, so as to rule out the possibility that the records belong to an imposter who has visited the dentist immediately before registration in the data base in order to obtain dental records under an assumed name.

As discussed above, the collection of physiological identifiers in the enrollment phase and in the modification phase makes it difficult for an imposter to pose as a user. What if, however, a brazen imposter were actually to seek to register as a user under the name of a third party? In such a case the imposter's physiological identifiers would be associated in the data base with at least some deposited personal information of the third party, because identity theft depends on associating personal information of the third party with the thief. In our example, however, the imposter is at greater risk than normal, because the imposter's set of physiological identifiers has been deposited. In accordance with a further embodiment of the present invention, in order to protect the data base, at least with the permission of a user who is enrolling in the data base, or as a condition of use of the data base, the sponsor of the data base may make these physiological identifiers and the name of the user available to law enforcement authorities for determining whether there is an outstanding claim of identity theft by a person having the name of the user and whether a person having one or more physiological identifiers matching those of the user has a criminal record. Alternatively, or in addition, the user may deposit or be required to deposit medical information (in the manner described in the previous paragraph) that provides further physiological identification of the user. When the information deposited shows characteristics associated with the user that have roots extending back many years in time (for example, the knee surgery on the user, resulting in scars on the right knee, occurred more than ten years before the information deposit—or dental records over the past decade), then the identity of the user is much less likely a recent fabrication.

Consequently, the generous deposit of medical information we have described previously can serve as a backup set of physiological identifiers, which can be invoked under circumstances wherein the bona fides of the user is being challenged (that is, when the user is accused of being an imposter). Moreover, the imposter is much less likely to have medical information having roots extending back many years in time that would confirm his identity. The user's deposit of medical information may include, therefore, the name of the user's present dentist and of any former dentist in the past 10 years, and names of physicians and health care institutions having medical records, pertaining to the user, that extend over a period of years. In accordance with a further embodiment of the present invention, with the permission of the user, such medical records can be obtained and be made part of the user's deposit of information.

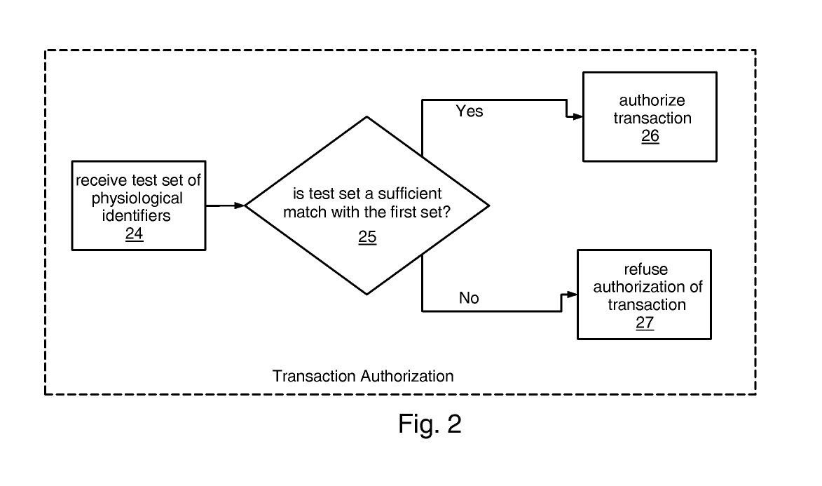

Once the enrollment phase 111 is complete, so that a first set of physiological identifiers has been obtained from the user, it is possible to use the enrolled information to authenticate a transaction in a manner generally analogous to the modification phase 112 discussed above in connection with FIG. 1. FIG. 2 thus presents a block diagram of an embodiment of the invention employed for authentication of a transaction in a manner analogous to the modification phase 112 of FIG. 1. Thus in box 24 there is received a test set of physiological identifiers from the subject. In box 25, there is conducted a test to determine whether there is a sufficient match between the test set of physiological identifiers and the first set of physiological identifiers obtained in box 12. If the match is not sufficient, then in box 27 authorization of the transaction is refused. Alternatively, if the match is sufficient, then, in box 26, the transaction is authorized. The transaction authenticated herein may be any type of transaction where it is important or desirable to establish that a party is authentic—for example, a sale involving property involving a significant amount of money, or access to an airplane for travel on a ticket already purchased.

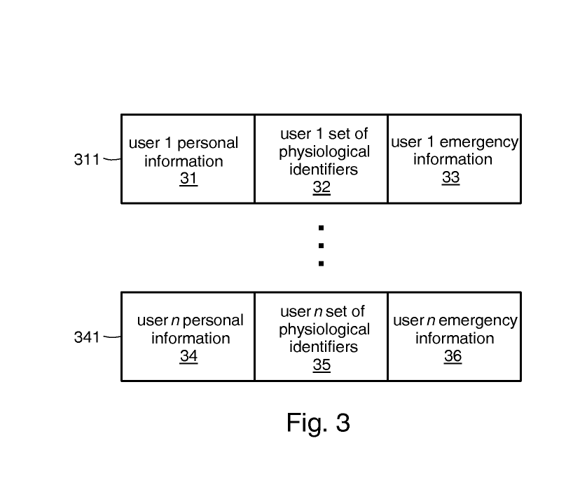

In FIG. 3 is illustrated in schematic form a structure for a database in accordance with an embodiment of the present invention. Row 311 illustrates a record for user 1. A first portion 31 of the record is used to store user 1 personal information. Another portion 32 of the record is used to store a set of physiological identifiers associated with user 1. Another portion 33 of the record is used to store emergency information pertinent to user 1. A similar structure is employed for each other user, illustrated in row 341 for user n, so that a first portion 34 of the record stores user n personal information, a second portion 35 stores user n set of physiological identifiers, and a third portion 36 stores user n emergency information. Although the structure of the database illustrated here provides a contiguous record for each user, it is within the scope of the present invention to provide a database where the information associated with a given user is stored in a manner that the information associated with a given user is not contiguous. For example, the information for a given user may be stored in various elements in various locations and accessed by an index that is common to all elements for any given user. A wide range of data structures may be implemented in accordance with procedures known in the art.

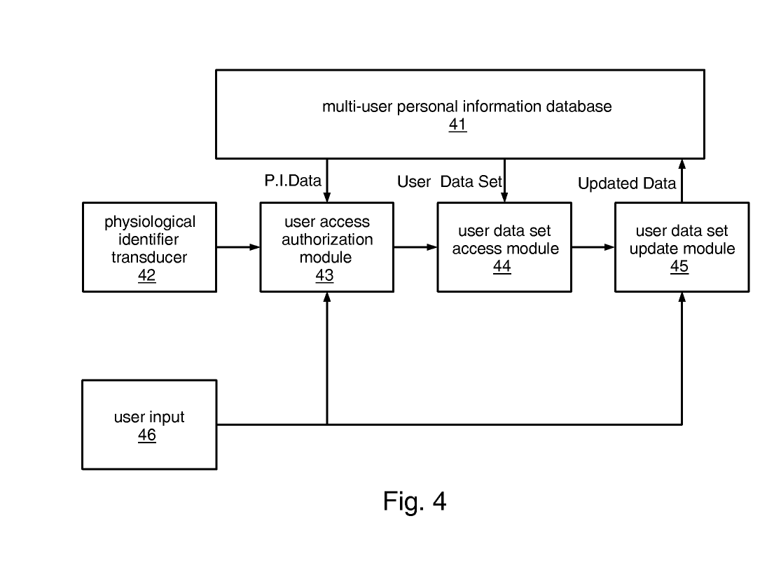

In FIG. 4 is shown a block diagram of an embodiment of the present invention providing a system for updating a personal information database 41 containing a data set for each one of multiple users. Each data set, as described in connection with FIG. 3, includes a user's personal information and a representation of a first set of physiological identifiers associated with the user. The system of this embodiment includes a physiological identifier transducer 42 having an output representing a physiological identifier associated with a subject. A user access authorization module 43, triggered by user input 46, is coupled to the physiological identifier transducer 42 and also to the database 41. This module obtains from the database 41 the representation of the first set of physiological identifiers associated with the user who the subject purports to be. The representation data is compared with the output of the physiological identifier transducer 42 to determine whether there is a sufficient match between the first set of physiological identifiers and the physiological identifier data produced by the transducer 42. When the match is sufficient, the subject is authenticated as the user.

The output of the user access authorization module 43 is provided to the user data set access module 44. The user data set access module 44 is coupled to the user access authorization module 43 and to the database 41. In the event that the user access authorization module 43 has authenticated the subject as the user, the user data set access module 44 accesses the user data set in the database 41. The user data set update module 45 is coupled to the user data set access module 44, as well as to the database 41 and to the user input 46; the user data set update module 45 then permits the user to update such user's corresponding data set in the database.

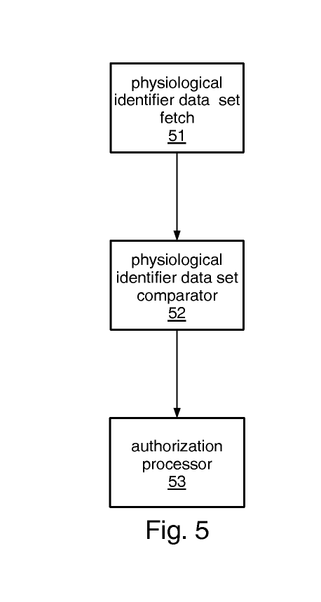

FIG. 5 illustrates operation of the user access authorization module 43 of FIG. 4. This module in fact includes three components. The first component is the physiological identifier data set fetch 51. This component obtains representation data from the database 41 pertaining to the first set of physiological identifiers associated with in the user who the subject purports to be. The component 51 passes the data fetched to the physiological identifier data set comparator 52, which compares the fetched data with the data from the physiological identifier transducer 42. The authorization processor 53 takes the output of the comparator 52 and provides an authorization signal to the user data set access module 44 in the event of a sufficient match found by the comparator 52.

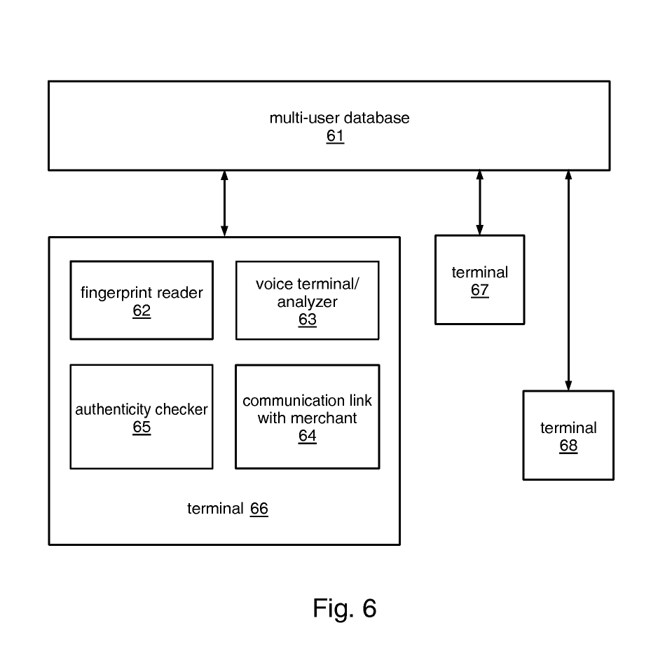

FIG. 6 is a block diagram of an embodiment of a system in accordance with the present invention providing a multiplicity of remotely distributed terminals in communication with a multi-user personal information data base. The multi-user database, item 61, is a database of the general type described above in connection with FIGS. 1 through 4. The database includes a data set pertinent to each user. Each data set includes a first set of physiological identifiers associated with the user. Each data set also includes such user's personal information obtained from the user, and optionally such user's medical information. A multiplicity of remotely distributed terminals, shown here as items 66, 67, and 68, are in communication with the database 61 over one or more networks. For example, the terminals 66-68 may be in communication with the database 61 over the Internet. Each of these terminals may include similar components, and for convenience we discuss the components of terminal 66. The terminal of this embodiment includes a fingerprint reader 62 and a voice terminal/analyzer 63. Each of the items 62 and 63 is, more broadly stated, a physiological identifier transducer, namely a device that transforms physical information, derived from a physiological feature of a human subject that is capable of uniquely identifying the subject, into computer-readable data useful for identifying the subject. (Alternatively or additionally, the physiological identifier transducer may be employed). Thus a user may utilize the fingerprint reader 62 and the voice terminal/analyzer 63 to provide a set of physiological identifiers that are represented and stored as part of such user's data set in the general manner described above in connection with FIG. 1.

Alternatively, or in addition, the user may wish to authenticate a transaction being made with a merchant. In this connection, the user may utilize either the fingerprint reader 62 or the voice terminal/analyzer 63, or both of them, from which may be derived a test set of physiological identifiers in a manner described previously in connection with FIG. 2. The authenticity checker 65 is then used to retrieve physiological identifier data stored as part of the user's data set in the database 61 and then to determine whether data from the test set of physiological identifiers sufficiently matches the corresponding retrieved data. The results of the match determination are then communicated with the merchant using the communication link 64.

Although the authenticity checker 65 is shown in FIG. 6 as part of the terminal 66, it may in fact be located remotely from the terminal over a suitable network, and may be conveniently located at the same network node, for example, as the database 61. In such a case, the physiological identifier transducer data from the fingerprint reader 62 and the voice terminal/analyzer 63 may be transmitted over the network to the remotely located authenticity checker for determination of the sufficiency of the match with the corresponding retrieved data. Similarly, the communication link 64 may optionally run from a location other than the terminal to the merchant; for example, where the checker is physically adjacent to the database 61, the link 64 may run from the checker to the merchant. In a simple embodiment, the authenticity checker 65 is part of the terminal 66 and includes a display for readout by a human operator; and the link 64 is a manually operable telephone providing a dial-up telephone connection to the merchant. In this manner, a human operator may supervise operation of the physiological identifier transducers, and may telephone the merchant with the results of the authenticity checker. Alternatively, or in addition, the communication link 64 may be over a network, including over the Internet, and the results of the authenticity checker 65 may be automatically sent to the merchant.

It is within the scope of embodiments of the present invention to provide in the manner described in connection with FIG. 6 a very large number of terminals dispersed over a geographically large region embracing one or more political subdivisions, countries, and even continents. The terminals may be located in pre-existing facilities of existing enterprises, such as banks, travel agencies, or insurance agencies. In this manner an individual may effectuate enrollment in accordance with FIG. 1 and later authenticate a transaction in the manner of FIG. 2 merely by going to a local terminal, with the result of the later authentication session being transmitted to the merchant via the communication link. As an alternative to using a terminal for authentication alone, it is equally possible to use a terminal to enter into the transaction simultaneously with the authentication process.

In FIG. 6, we have shown use, in connection with a single database 61, of two different types of physiological identifiers, fingerprint and utterance characteristics, one type of which (fingerprint) is more reliable than the other (utterance characteristics). On the other hand, the use of utterance for authentication may be accomplished over a telephone without the need for the user to go to a different physical location. It is within the scope of an embodiment of the present invention to store data pertaining to a plurality of physiological identifiers, and, with respect to a given transaction or circumstance, to select an identifier for authentication purposes that offers a desired trade-off between convenience and reliability. In other words, the use of a plurality of physiological identifiers permits adjustment of the reliability of the physiological identifier (by selecting the appropriate type of identifier) to suit a desired level of reliability and therefore, for example, pricing. While FIG. 6 has illustrated fingerprint and utterance characteristics as the physiological identifiers utilized, other combinations may be utilized, for example, iris configuration and facial appearance.

The telephone may be used for providing an utterance for authentication in a manner previously described. In this context, although in FIG. 6 we have shown the physiological identifier transducer for utterances as a voice terminal/analyzer, in fact in related embodiments, the analyzer may be located remotely from the voice terminal. For example, the voice terminal may be as simple as a telephone in communication over a telephone line with a remotely located analyzer, and the analyzer may, for example, be physically adjacent to the database 61. In this manner may institute a telephone call to a central facility that includes the database 61, and the user's utterance may be analyzed with the resulting data run through an authenticity checker and the results provided to the merchant. In lieu of a telephone call to the central facility, the communication of the utterance may be over the Internet. Such an approach, while not as reliable as one that utilizes a human-monitored fingerprint reader, nevertheless provides a physiological identifier that lowers the risk of a fraudulent transaction. In other words, telephone authentication is well suited to circumstances where remote authentication is desired but physically distributed terminals of the type shown in FIG. 6 are not convenient.

An authentication system of the type described in various embodiments may be employed in a wide range of circumstances, including not only E-commerce but also, for example, distance learning and examination taking. In distance learning, the authentication system can be used to confirm actual attendance by persons purporting to be enrolled, and in examination taking, to confirm the authenticity of persons taking examinations. Thus, a system of the present type may be employed in any situation where a person is not physically present or is incapacitated, so normal in-person authentication is not possible or is difficult, and another party needs information about the person for the conduct of some transaction or matter.

The use of the various embodiments described above can reduce the risk of identity theft, because a merchant, intending to rely on the implicit representation that a subject is the one who the subject purports to be, now has the benefit of a physiological identifier (as opposed to merely a password, etc., which may be stolen) confirming the subject's authenticity. Moreover, in a case where identity has already be stolen and a fraud perpetrated, a victim who has previously established a user data record in a multi-user personal information data base of the type described above may utilize the information in the user data record to reestablish identity with one or more merchants. Indeed, an imposter who seeks to steal the identity of a user having a data record that is registered in the multi-user database, under circumstances where a reliable physiological identifier is employed to authenticate a transaction, must risk giving a fingerprint, for example, to the organization managing the multi-user database. Because the imposter's fingerprint may then be accessed by law enforcement officials, for example, using normal warrant procedures, the chances of successful fraud are significantly reduced and a significant deterrent to fraud is also provided.

Another context in which systems of the present type are applicable in various embodiments is in connection with access to a user's medical information. Although access to a user's personal information (as defined above) is desirably restricted to merchants under controlled circumstances, access to at least some of a user's medical information (as defined above) (even when in the same database as the user's personal information) may be made more broadly available to health care providers when a user is physically incapacitated. In this context it is convenient for the user to carry a card or other token to indicate that the user has provided medical information to the applicable multi-user database and even to identify in some manner (for example, by record number or a suitable alphanumeric identifier) the particular data record applicable to the user's medical information. (Similarly, such an identifier may confirm to merchants that the user's personal information has been stored in the database, as well as to facilitate look up of data in the data base.) In cases of emergency, and the injured or ill person cannot be identified, a physiological attribute, for example, a fingerprint, of such person might be used to identify the person for the purpose of accessing the relevant record in the data base. A health care provider may then use information about the user to access pertinent medical information of the user. In this fashion, for example, the health care provider can have information permitting persons in a caring relationship to the user to be notified, and health care providers may be informed of information affecting treatment of the user. Current information about the status of the user's regular health care provider and health insurance may also be provided in this manner.

In implementing various embodiments described above, it is desirable for the manager of the database to prompt the user on a periodic basis, for example yearly, for an update of the user's personal information and medical information. When updated information is received, the data set of the user can be modified when appropriate authentication, as described, for example, in connection with FIG. 1, has been obtained from the user. It is a feature of embodiments of the present invention that the user's data set cannot be modified, for example, by a credit reporting agency, but only by the user on proper authentication. Given the inherent reliability of a database administered in this manner, it is within the scope of embodiments of the present invention to permit the database administrator on appropriate user authorization to provide change of address information, for example, to merchants.

Pursuant to a further embodiment of the present invention, the sponsor of a personal information data base of the type disclosed herein—which we sometimes call a biometric-protected personal information data base—may provide a guarantee to a credit card issuer or other merchant that if the merchant first utilizes the sponsor's data base to authenticate the contact information or a change of address (offered by a purported user) before the merchant extends credit or effectuates a change of address, for example, then the liability of the merchant for a fraudulent transaction may be reduced or eliminated. In this way, the sponsor may provide a financial incentive to the merchant and justify charging the merchant for the opportunity to utilize the data base. The financial incentive need not be premised exactly on a guarantee, but may also be premised on lower discount rates from the credit card processor, for example.

The authentication of contact or other data by the sponsor of such a biometric-protected personal information data base may be as simple as confirming whether a billing address offered by a purported user is in fact the actual billing address of a real user who has the name and account of the purported user. In fact “address verification service” (“AVS”) is known in the credit industry and is a method used to reduce a merchant's risk of credit card fraud. See, for example, Cheryl Lindloff, “Address Verification Service: To Catch a Thief,” (June 2000), available at www.inc.com/articles/2000/06/19976.html and incorporated herein by reference. However, address verification that utilizes a biometric-protected personal information data base has special benefits, because the address data (and other data) are inherently more reliable than personal information gathered under other circumstances. Accordingly, address and other authentication service utilizing a biometric-protected personal information data base are embodiments of the present invention.

When a sponsor of a biometric-protected personal information data base offers an address verification service or other authentication service to a merchant, at least some of the time the sponsor will be notifying the merchant that the data offered by the merchant does not match actual user data in the data base. A non-match is an indication potentially of an attempt at fraudulent use of the user's identity. In a further embodiment of the present invention, the actual user is notified in the event that there is a non-match of data offered by the merchant with that of the actual user in the data base. The user may be notified of the non-match event using one or more communication facilities known in the art, including a government-run mail service, e-mail, telephone, mobile telephone, courier, and variations on these facilities, including text messaging and paging. The benefit to the user of such notification is an opportunity to take action to reduce the risk of identity theft by (for example) closing a credit card account, notifying credit reporting agencies, and notifying law enforcement agencies.

In a further embodiment, a user may be provided with web access to account information about the user's data stored in the biometric-protected personal information data base. The web access may be suitably protected using methods known in the art, such as the Secure Sockets Layer (SSL) (see for example, www.openssl.org, a web site devoted to an open source toolkit for implementing SSL) and gated by at least one of a password and a physiological identifier, preferably which has been registered in the biometric-protected personal information data base. Such account information may include, among other things, a report of non-match events.

In the event that there are many non-match events (one would hope that normally there would not be), such events may be grouped according to date and time or merchant or other criteria for purposes of reporting to the user. In a further embodiment, at the option of the user, reporting may be condensed, and only selected representative non-match events (for example, the most recent one in each category) are reported to the user.

In a further related embodiment, the user may be notified of the non-match event, using one or more facilities previously described, by using contact data supplied by the user as personal information in the data base; the benefit of using such contact data is that the user-supplied data can be expected to be reliable, since it has been supplied by the user under controlled conditions.

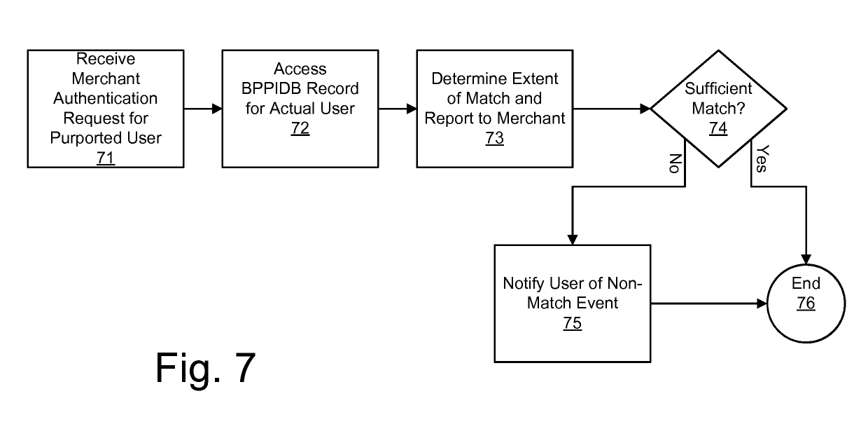

FIG. 7 is a block diagram illustrating a representative process implementing user notification of a non-match event when a sponsor of a biometric-protected personal information data base (BPPIDB) offers an address verification service or other authentication service to a merchant. Some or all of these processes may be computer implemented, using techniques well-known in the art. In sub-process 71, the sponsor of the BPPID receives a merchant-initiated authentication request for an individual claiming to have the identity of a user of the BPPID. Such a request may, for example, as previously described, be for confirmation of the individual's billing address. In sub-process 72, the pertinent record for the corresponding actual user in the BPPIDB is accessed with the purpose of obtaining corresponding information (such as billing address in our example) for the actual user. In sub-process 73, data from the accessed actual user record is compared with data supplied by the merchant in sub-process 71 and the extent of match is reported to the merchant. The form of report on the extent of match may be in accordance with prevailing standards for address verification services or may be customized by the sponsor as desired. Thus the report to the merchant may be in an AVS format, such as:

X=exact match, address and nine-digit zip code

Y=exact match, address and five-digit zip code

A=address matches, zip code does not

W=nine-digit zip code matches, address does not

Z=five-digit zip code matches, address does not

N=address and zip code do not match

U=address information is unavailable

R=retry, system is unavailable

S=service is not available

E=data not available/error invalid

or it may contain less or more information. In process 74, there is a test for whether the match is sufficiently good to avoid notifying the user, or equivalently, whether the match is sufficiently poor that the user should be notified owing to the risk of identity theft. The user is notified in sub-process 75 in the event the match is sufficiently poor that the user should be notified.

Because it is the actual user's personal information that is being tested by the merchant, the user is reasonably entitled to at least the same information as the merchant. Accordingly, in an embodiment of the present invention, when the merchant is notified in sub-process 75 of a non-match event in the case of AVS, for example, the user may be provided with the same match information as is provided to the merchant. In fact, in some embodiments of the present invention, sub-process 74 is optional, and the user may be notified of the outcome of all merchant authentication requests, even those reporting an exact match. The process ends at sub-process 76 when the user is notified or there is a determination that the user will not be notified owing to a sufficient match of data of the purported user with the actual user.

Although our description above has sometimes referred to a “purported user,” we use the term to refer to an individual claiming to have the identity of a user of the data base. In fact, it is not even necessary in this description or the following claims that an individual who is the subject of authentication in accordance with processes described in this application claim to be enrolled in the BPPIDB in order for the processes described herein to be applicable. A general query may first be made to the sponsor of the BPPIDB whether a person having the name of the relevant individual is enrolled in the data base, and if the person is not enrolled, the fact of non-enrollment may be returned to the merchant; otherwise, data from the individual may be handled just as described above.

When a user has completed the modification phase 112 as discussed previously in connection with FIG. 1—for example to modify a billing address—in accordance with an embodiment of the present invention, the sponsor of the data base, at the option of the user, directly notifies merchants where the user has accounts (for example credit card issuers) of the modified data. Alternatively, or in addition, merchants where the user has accounts may be permitted, at the option of the user, to access the updated information from the data base. It should be noted that various embodiments of the present invention do not require providing the merchant directly with personal data in the data base. Instead, for example, when a transaction is being authenticated, the merchant need provide the data base sponsor only with a user's physiological identifier(s) (or a representation thereof) and a user's purported identity; the sponsor, upon checking the data base, can thereupon inform the merchant that, for the purported individual, there is a match between the physiological identifier(s) in the data base and the physiological identifier(s) obtained by the merchant. The match determination may be carried out under control of the data base sponsor, or, alternatively, under control of the merchant.

An institution such as a bank, in cooperation with the sponsor of a data base administered in accordance with various embodiments described above, may offer a service, to protect a user, in which a user requires authentication, via use of the data base, of any check written over a certain amount. Indeed, such an approach may be utilized in connection not only with respect to a check but also with respect to any mechanism (credit or debit card transaction, electronic wallet transaction, digital money transaction, etc.) by which funds may be transferred. The user may require authentication (via utilization of the data base) for any instance in which the funds to be transferred exceed a specified amount. In a related embodiment, the user may establish a list of exceptions to the authentication requirement, so that checks can be conveniently written to a spouse, etc.

What is claimed is:

1. A method of administering registration in a data base, stored in a digital storage medium, of personal information, in a manner tending to assure integrity of the personal information therein so that it can be used in authentication of an individual in a transaction, the method comprising:
in an enrollment phase,
(a) initially obtaining, from each user with respect to whom data is to be placed in the data base, personal information of such user, the content of such personal information initially established by such user; and
(b) also initially obtaining, from each such user, a first set of physiological identifiers associated with such user; and
(c) storing, in the digital storage medium, a data set, pertinent to such user, that includes such user's obtained personal information and a representation of the obtained first set of physiological identifiers associated with such user so that such user becomes an enrolled user; and
in a modification phase, permitting a subject claiming to be a specified user to modify the specified user's personal information in the stored data set pertinent to such user only if (i) the subject provides a new set of physiological identifiers and (ii) it is determined, by recourse to the
stored data set, that there is a sufficient match between at least one member in the new set and a corresponding member of the first set, so that the subject is authenticated as the specified user,
wherein at least one of obtaining the first set of physiological identifiers and obtaining the new set of physiological identifiers is performed under supervision so to assure authenticity of the identifiers and integrity of processes by which any personal information of the specified user in the data base is stored or modified;
so that there is established a repository of personal information using physiological identifiers to protect against unauthorized modification; and
using the database to authenticate a selected one of the enrolled users in a transaction involving an activity external to the database.

2. A method according to claim 1, wherein both obtaining the first set of physiological identifiers and obtaining the new set of physiological identifiers is performed under supervision.
